(19) United States
(12) Patent Application Publication
(10) Pub. No.: US 2020/0160548 A1
(43) Pub. Date: May 21, 2020

(54) METHOD FOR DETERMINING DISPARITY OF IMAGES CAPTURED MULTI-BASELINE STEREO CAMERA AND APPARATUS FOR THE SAME

(71) Applicants: Electronics and Telecommunication Research Institute, Daejeon (KR); Kyungpook National University Industry-Academic Cooperation Foundation, Daegu (KR)

(72) Inventors: Joung Il YUN, Daejeon (KR); Gi Mun UM, Seoul (KR); Jin Hwan LEE, Daejeon (KR); Sang Woon KWAK, Daejeon (KR); Soon Yong PARK, Daegu (KR)

(73) Assignees: Electronics and Telecommunications Research Institute, Daejeon (KR); Kyungpook National University Industry-Academic Cooperation Foundation, Daegu (KR)

(21) Appl. No.: 16/687,441

(22) Filed: Nov. 18, 2019

(30) Foreign Application Priority Data
Nov. 16, 2018 (KR) 10-2018-0141523
Nov. 18, 2019 (KR) 10-2019-0147508

(51) Int. Cl. G06T 7/593; H04N 13/10

(52) U.S. Cl. CPC G06T 7/593; H04N 2013/0081; G06T 2207/10012; H04N 13/10

(57) ABSTRACT

Disclosed is a method of determining a disparity of an image generated by using a multibaseline stereo camera system. The method includes determining a reference parity between a reference image and a target image among multiple images generated by using a multi-baseline stereo camera system, determining an ambiguity region in each of the multiple images on the basis of a positional relationship among the multiple images or among cameras in the multibaseline stereo camera system, and determining a disparity for each of the multiple images by determining a matching point in each of the ambiguity regions of the respective images.

### CROSS REFERENCE TO RELATED APPLICATION

The present application claims priority to Korean Patent Application No. 10-2018-0141523 and 10-2019-0147508, filed Nov. 16, 2018, and Nov. 18, 2019 respectively, the entire contents of which is incorporated herein for all purposes by this reference.

### BACKGROUND OF THE INVENTION

### Field of the Invention

The present disclosure relates to an image processing method and apparatus. More particularly, the present disclosure relates to a method and apparatus for processing images generated by a multibaseline stereo camera system.

### Description of the Related Art

A multibaseline camera system is one kind of multi-view camera systems. A multibaseline camera system requires the cameras to be arranged side by side on the same plane which may a horizontal plane or a vertical while a multi-view camera system allows the cameras to be arranged at arbitrarily different positions in a three-dimensional space.

When a multibaseline camera system is used, images generated by the respective cameras arranged side by side on a horizontal plane or a vertical plane are almost the same in terms of background and foreground objects present in the images. When a lateral shift of the multibaseline camera system is insignificant, each of the images generated by the respective cameras of the multibaseline camera system has almost the same scene in which objects in each of the images are overlapped when the images are superimposed. Generation of a multibaseline stereo image is based on calculation of a disparity between objects present in the overlapped regions of the images.

### SUMMARY OF THE INVENTION

Stereo matching is used to check a disparity between images captured by respective cameras. However, the stereo matching basically checks stereo vision matching (i.e., matching between only two images). Even when generating a multibaseline stereo image, the characteristics of multibaseline images are not considered and only general stereo matching is used. That is, a technique of determining a disparity for each of multiple images to take advantage of the characteristics of multibaseline images has not being used.

An object of the present disclosure is to provide a method and apparatus for effectively determining a disparity for each of multibaseline images.

Another object of the present disclosure is to provide a method and apparatus for rapidly and accurately determining a disparity for each of multiple images while reflecting characteristics of a multibaseline camera system or a multibaseline image.

It will be appreciated by those skilled in the art that objects, features, and advantages of the present disclosure are not limited to the ones mentioned above and other various objects, features, and advantages can be clearly understood from the following description.

According to one aspect of the present disclosure, there is provided an image disparity determination method based on a multibaseline stereo camera system. The method includes: determining a reference disparity between a reference image and a target image among multiple images generated by using a multibaseline stereo camera system; determining ambiguity regions for the respective images on the basis of the reference disparity and a positional relationship among the images generated by using the multibaseline stereo camera system; and determining a disparity for each of the images by determining a matching point in each of the ambiguity regions of the respective images.

According to another aspect of the present disclosure, there is provided an image disparity determination apparatus based on a multibaseline stereo camera system. The apparatus includes: a reference disparity determination unit for determining a reference disparity between a reference image and a target image among multiple images generated by using the multibaseline stereo camera system; an matching region determination unit for determining an ambiguity region in each of the multiple images on the basis of the reference disparity and a positional relationship among the multiple images generated by using the multibaseline stereo camera system; and a disparity determination unit for determining a disparity for each of the multiple images by determining a matching point in each of the ambiguity regions of the respective images.

The objects, features, and advantages briefly summarized above with respect to the present disclosure are merely exemplary aspects of the present disclosure described which will be described in detail below, and do not limit the scope of the present disclosure.

According to the present disclosure, it is possible to provide a method and apparatus for effectively determining a disparity for each of multibaseline images.

According to the present disclosure, it is possible to provide an apparatus and method for rapidly and accurately determining a disparity for each of images while reflecting structural characteristics of a multibaseline stereo camera system or a multibaseline image.

It will be appreciated by those skilled in the art that objects, features, and advantages of the present disclosure are not limited to ones described above, and the above and other objects, features, and other advantages of the present disclosure will be more clearly understood from the following detailed description.

### BRIEF DESCRIPTION OF THE DRAWINGS

FIG. 1 is a diagram illustrating the configuration of a multibaseline stereo camera system and the configuration of a multibaseline stereo image which are the basis of an image disparity determination apparatus according to one embodiment of the present disclosure;

FIG. 2 is a block diagram illustrating the image disparity determination apparatus according to one embodiment of the present disclosure;

FIG. 3 is a diagram illustrating an exemplary arrangement of images processed by the image disparity determination apparatus according to one embodiment of the present disclosure;

FIG. 4A is a diagram illustrating baselines and images processed by a minimum baseline-based disparity determination method performed by an image disparity determination apparatus according to an embodiment of the present disclosure;

FIG. 4B is a diagram illustrating baselines and images processed by a maximum baseline-based disparity determination method performed by an image disparity determination apparatus according to an embodiment of the present disclosure;

FIG. 5 is a flowchart illustrating a sequential flow of an image disparity determination method according to another embodiment of the present disclosure;

FIG. 6 is a flowchart illustrating a sequential flow of an image disparity determination method according to a further embodiment of the present disclosure; and

FIG. 7 is a block diagram illustrating the configuration of an exemplary computing system by which an image disparity determination method and apparatus according to an exemplary embodiment of the present disclosure are implemented.

### DETAILED DESCRIPTION OF THE INVENTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening there between. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance.

Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

Hereinafter, embodiments of the present disclosure will be described in conjunction with the accompanying drawings.

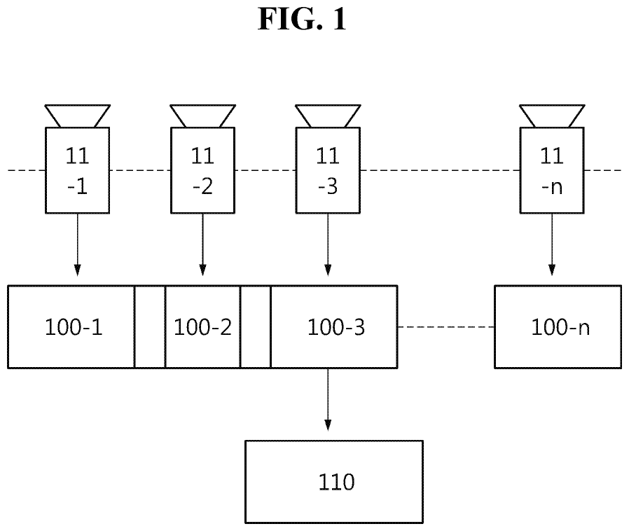

FIG. 1 is a diagram illustrating the configuration of a multibaseline stereo camera system and the configuration of a multibaseline-based stereo image which are the basis of an image disparity determination apparatus according to an exemplary embodiment of the present disclosure.

A multibaseline stereo camera system 10 is configured with a plurality of cameras 11-1, 11-2, 11-3, . . . , and 11-n arranged side by side at regular intervals in a horizontal direction or a vertical direction. The multiple cameras 11-1, 11-2, 11-3, . . . , and 11-n produce multiple images 100-1, 100-2, 100-3, . . . , and 100-n, respectively. The multibaseline stereo camera system 10 generates a multibaseline stereo image 110 by combining the multiple images 100-1, 100-2, 100-3, . . . , and 100-n.

The arrangement of the multiple images 100-1, 100-2, 100-3, . . . , 100-n may be determined depending on the positional relationships of the multiple cameras 11-1, 11-2, 11-3, . . . , 11-n. In an exemplary embodiment of the present disclosure, one of the images 100-1, 100-2, 100-3, . . . , and 100-n is defined as a reference image. In addition, an image used to set a reference disparity in conjunction with the reference image, among the multiple images 100-1, 100-2, 100-3, . . . , and 100-n, is defined as a target image. For example, when the images 100-1, 100-2, 100-3, . . . , and 100-n are arranged in the horizontal direction, a first image 100-1 disposed at the leftmost position may be set as the reference image, and second image 100-2 which is nearest the reference image (for example, first image 100-1) may be set as the target image. Alternatively, an n-th image 100-n which is farthest from the reference image (for example, first image 100-1) may be set as the target image.

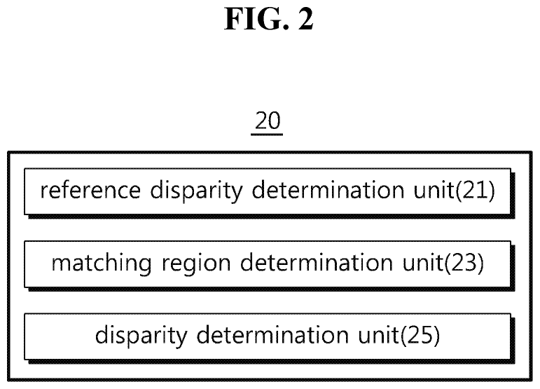

FIG. 2 is a block diagram illustrating the image disparity determination apparatus according to the exemplary embodiment of the present disclosure.

Referring to FIG. 2, the image disparity determination apparatus according to the exemplary embodiment of the present disclosure includes a reference disparity determination unit 21, a matching region determination unit 23, and a disparity determination unit 25.

The reference disparity determination unit 21 determines the target image and the reference image among multiple images 100-1, 100-2, 100-3, . . . , and 100-n that are the basis for generation of a multibaseline stereo image (refer to reference numeral 100 in FIG. 1) and determines a disparity (i.e., reference disparity) between the reference image and the target image.

The reference disparity is determined through stereo matching between the reference image and the target image. Therefore, the reference disparity determination unit 21 determines the reference disparity through stereo matching. That is, the reference disparity determination unit 21 sets a reference point within the reference image and detects a target point corresponding to the reference point, within the target image. For the detection of the target point in the target image, an SGM cumulative cost function or a matching cost function such as sum of squared difference (SSD), sum of absolute difference (SAD), mutual information (MI), or Census may be used.

The matching region determination unit 23 determines ambiguity regions in the respective images 100-1, 100-2, 100-3, . . . , and 100-n on the basis of a positional relationship among the multiple cameras 11-1, 11-2, 11-3, . . . , 11-n). The disparity determination unit 25 determines a matching point in each of the ambiguity regions and determines the disparity of each of the multiple images. Since the disparity determination unit 25 is configured to determine the disparity of each of the multiple images by performing operations only on the ambiguity regions determined by the matching region determination unit 23, the operation of the matching region determination unit 23 and the operation of the disparity determination unit 25 will be described together.

Since the second image 100-2 that is nearest the reference image (for example, first image 100-1) or the n-th image 100-n that is farthest from the reference image (for example, first image 100-1) is set as the target image, the matching region determination unit 23 may differently set the ambiguity regions, depending on which image is set as the target image.

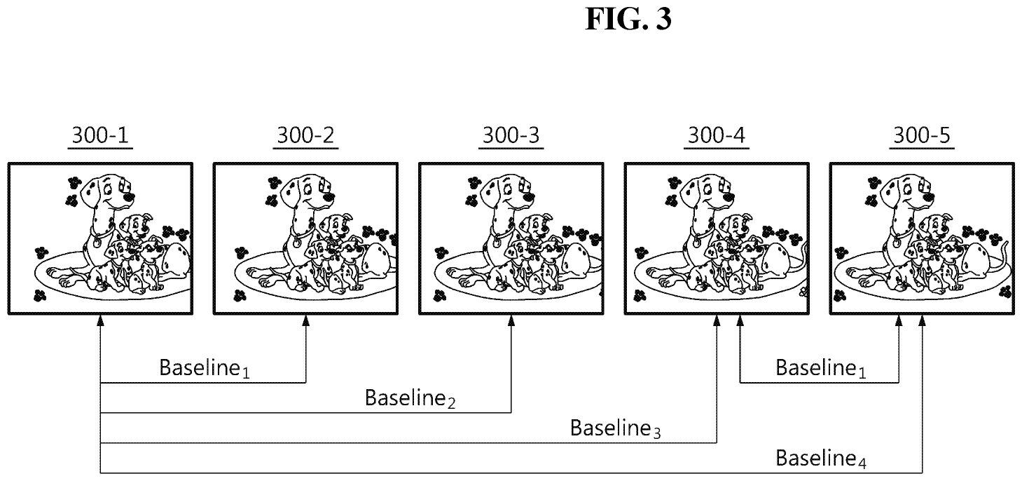

For example, referring to FIG. 3, a multibaseline stereo camera system produces five images 300-1, 300-2, 300-3, 300-4, 300-4, and 300-5. Since the images 300-1, 300-2, 300-3, 300-4, 300-4, and 300-5 are respectively captured by five cameras located at different positions, each of the images has a disparity with respect to another. In this case, a first image 300-1 that is captured by a first camera located at the leftmost position, among the five images, may be determined as a reference image, and a distance between the reference image 300-1 and each of the images 300-2, 300-3, 300-4, 300-4, and 300-5 is defined as a baseline. An approach of calculating a reference disparity by setting a second image 300-2 which is nearest the reference image 300-1 as the target image is called a minimum baseline-based disparity determination method. On the other hand, an approach of calculating a reference disparity by setting a fifth image 300-5 which is farthest from the reference image 300-1 as the target image is called a maximum baseline-based disparity determination method.

### Minimum Baseline-Based Disparity Determination Method

When a second image 400-2 which is nearest a reference image (for example, first image 400-1) is set as a target image, a matching region determination unit 23 determines an ambiguity region which is equal to an integer multiple of a reference disparity according to a positional relationship among cameras.

When a reference point p in the first image 400-1 is an object point present on a planar surface parallel to an image plane of a camera and when the same object point appears at a position p+d in the second image 400-2, the same object point may appear at a position p+2d in a third image 400-3, a position p+3d in a fourth image 400-4, and a position p+4d in a fifth image 400-5.

However, since an ideal condition is not satisfied, the matching points in the third, fourth, and fifth images 400-3, 400-4, and 400-5 may have a small match error due to an increased baseline. For example, when the same object point coincides with the reference point p in the first image 400-1 and with the target point p+d in the second image 400-2, the matching point may be located in an area of p+2d±1 in the third image 400-3. In order to compensate for the match error, the matching region determination unit 23 sets an ambiguity region on the basis of a positional relationship among the multiple images 400-1, 400-2, 400-3, 400-4, and 400-5 or a positional relationship among the multiple cameras.

α refers to an element in an ambiguity region A. When the ambiguity region is set to ±N, the ambiguity region A includes {−N, −N+1, . . . , 0, 1, . . . , N−1, N} as elements, and the α is any one element within the ambiguity region A.

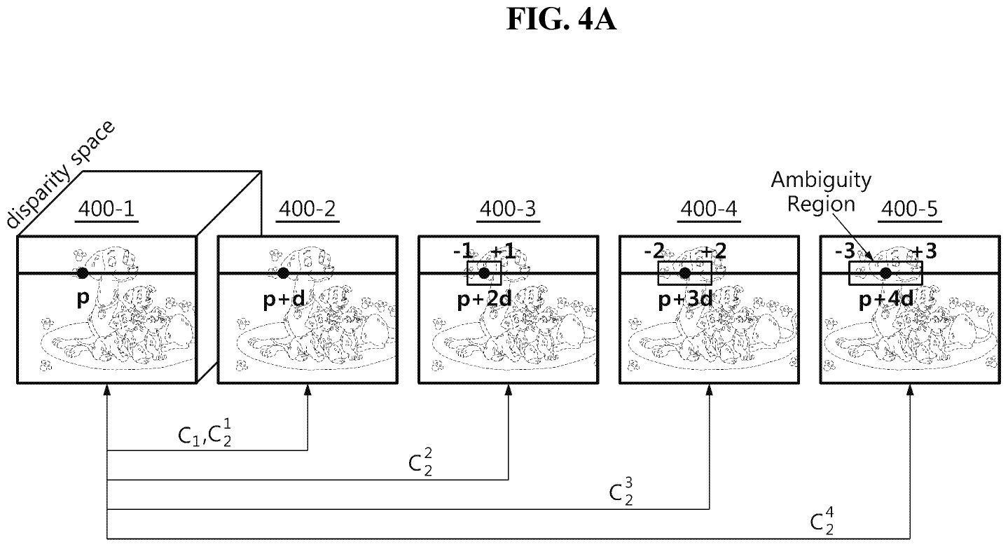

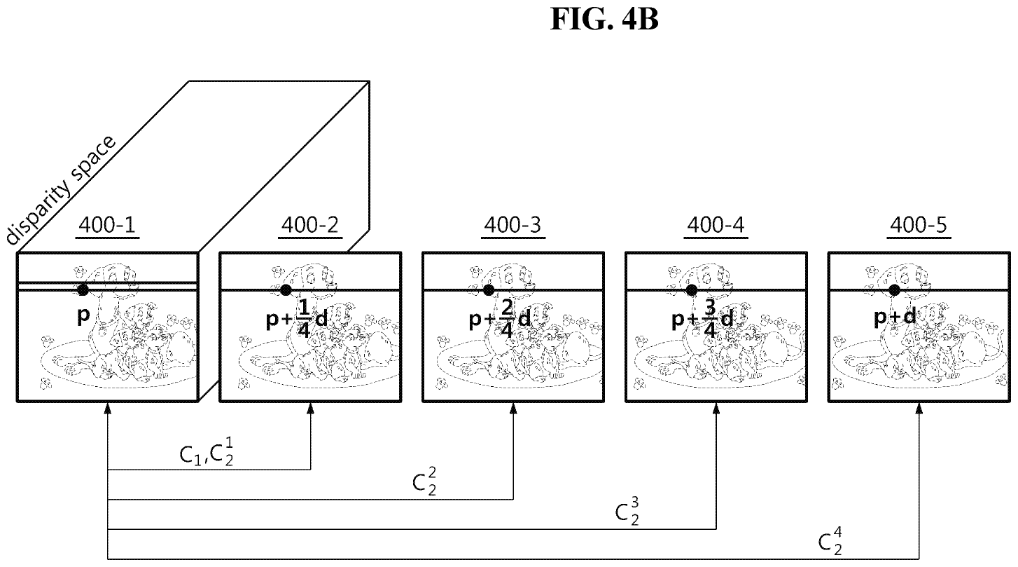

In the present disclosure, since the baseline increases, the disparity is increased to i•d, the ambiguity region is set such that a search range for the least SSD value is increased to be proportional to i. In the example illustrated in FIG. 4A, the ambiguity region is set to ±(i−1).

Next, the disparity determination unit 25 determines a disparity using the set ambiguity region. For example, the disparity determination unit 25 determines a disparity for each of the images 100-1, 100-2, 100-3, . . . , and 100-n by performing an operation of Equation 1.

$${C}_{2}^{1} ( p , d ) = {min}_{a ∈ A} ( SSD ( {Img}_{1} ( p ) , {Img}_{1} ( p + i \cdot d + a ) ) + {P}_{a} ) \qquad [ Equation 1 ]$$

As described above, with respect to the third image, the matching region determination unit 23 and the disparity determination unit 25 determine the least SSD values for the reference point p and three other points p+2d'1, p+2d, and p+2d+1 within an ambiguity region of ±1 in the third image. On the other hand, with respect to the fourth image, the matching region determination unit 23 and the disparity determination unit 25 determine the least SSD values for the reference point p and other five points within an ambiguity region of ±2.

In addition, the disparity determination unit 25 is configured to apply higher penalty values Pₐ to points spaced longer from the center position of the ambiguity region.

The disparity determination unit 25 may determine the disparity for each of the images through operations of Equation 2 and Equation 3. The disparity determination unit 25 calculates a color coherence cost function C₂(p, d) between the reference image and each of the remaining images another image and determines the average of C₂ⁱ. A cumulative cost function Lᵣ(p, d) is calculated by applying SGM in a manner to multiply C₂(p, d) by a SSD cost value normalization coefficient of 1/λ and adding the product to an existing C₁(p, d).

$$\begin{matrix}{C}_{2} ( p , d ) = \frac{1}{N} {\sum }_{i = 1}^{N} {C}_{2}^{1} ( p , d ) & [ Equation 2 ] \\ {L}_{r} ( p , d ) = {C}_{1} ( p , d ) + \frac{1}{λ} {C}_{2} ( p , d ) + min ( a , b , c , d ) - E & [ Equation 3 ]\end{matrix}$$

### Maximum Baseline-Based Disparity Determination Method

As described above, an image that is farthest from the reference image may be set as the target image. In this case, the reference disparity determination unit 21 calculates a reference disparity between the reference image 400-1 and the target image 400-5 farthest from the reference image 400-1.

The matching region determination unit 23 and the disparity determination unit 25 may divide the reference disparity by C₁(p, d) or C₂(p, d). The C₁(p, d) is determined as a stereo matching cost between the reference image 400-1 and the target image 400-5 farthest from the reference image 400-1.

When the target point corresponding to the reference point p of the reference image 400-1 is set to a position p+d in the target image, p+d, the matching point in the fourth image 400-4 is set to a position

$$p + \frac{3}{4} d ,$$

the matching point in the third image 400-3 is set to a position

$$p + \frac{2}{4} d ,$$

and the matching point in the second image 400-2 is set to a position

$$p + \frac{1}{4} d .$$

In this case, the matching point corresponding to the target point in the target image (for example, the fifth image 400-5) needs to be determined by interpolating d-axis values of the respective positions

$$p + \frac{3}{4} d , p + \frac{2}{4} d , and p + \frac{1}{4} d$$

in the fourth, third, and second images 400-4, 400-3, and 400-2. Accordingly, The matching region determination unit 23 and the disparity determination unit 25 may calculate SSD cost values between the referenced image 400-1 and each of the images 400-2, 400-3, and 400-4 respectively, and normalize the calculated SSD cost values on the basis of the SSD cost value for the maximum baseline.

The final C₂(p, d) may be determined to be the average of the interpolated SSD cost values C₂ⁱ as in the minimum baseline-based technique, and SGM can be used by calculating the cumulative cost function (Lᵣ(p, d)) in the same manner.

That is, the matching region determination unit 23 and the disparity determination unit 25 may be calculated through the d-axis interpolation of the SSD cost values.

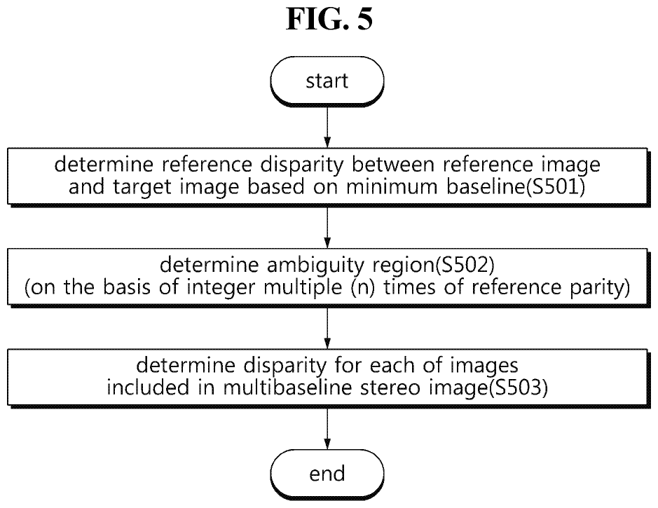

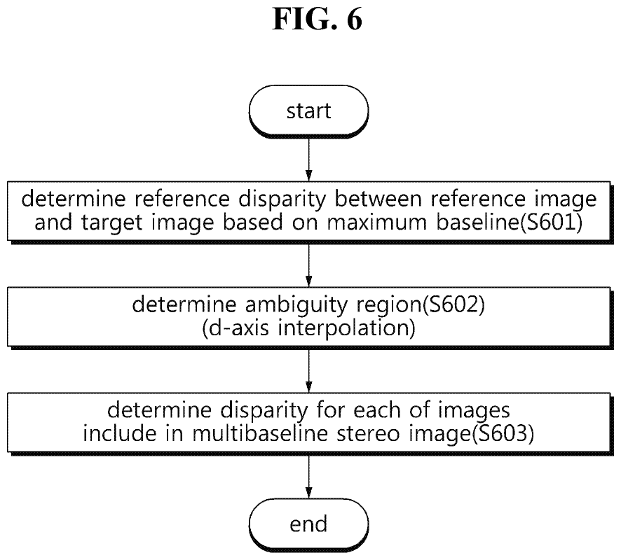

Hereinbelow, an image disparity determination method according to one embodiment of the present disclosure will be described in detail with reference to FIGS. 5 and 6.

The image disparity determination method according to one embodiment of the present invention may be performed by the image disparity determination apparatus according to one embodiment of the present invention. In the image disparity determination method according to one embodiment of the present disclosure, a method of calculating a disparity may vary depending on a target image setting condition. Specifically, a method of calculating a disparity by setting an image nearest the reference image as the target image is called a “minimum baseline-based disparity determination method”. On the other hand, a method of calculating a disparity by setting an image farthest from the reference image as the target image is called a “maximum baseline-based disparity determination method”. The image disparity determination method according to one embodiment of the present disclosure illustrated in FIG. 5 is an example of a minimum baseline-based disparity determination method, and an image disparity determination according to another embodiment of the present disclosure illustrated in FIG. 6 is an example of a maximum baseline-based disparity determination method.

FIG. 5 is a flowchart illustrating an image disparity determination method according to an exemplary embodiment of the present disclosure.

Referring to FIG. 5, in Step S501, an image disparity determination apparatus determines a reference image and a target image among multiple images 100-1, 100-2, 100-3, . . . , and 100-n that are the basis for generation of a multibaseline stereo image (110 in FIG. 1), and determines a disparity between the reference image and the target image as a reference disparity. The reference image may be a first image 100-1 and the target image may be a second image 100-2.

That is, the reference disparity can be determined through stereo matching between the reference image and the target image. Specifically, the image disparity determination apparatus determines the reference disparity through stereo matching. That is, the image disparity determination apparatus sets a reference point in the reference image and detects a target point corresponding to the reference point in the target image. The detection of the target point is performed by using an SGM cumulative cost function or a matching cost function such as sum of squared difference (SSD), sum of absolute difference (SAD), mutual information (MI), and Census.

In Step S502, the image disparity determination apparatus determines ambiguity regions in the respective images 100-1, 100-2, 100-3, . . . , and 100-n on the basis of a positional relationship among the multiple cameras 11-1, 11-2, 11-3, . . . , and 11-n.

The image disparity determination apparatus may sets the ambiguity regions that are set to be integer multiples of the reference disparity according to the positional relationship among the multiple cameras 11-1, 11-2, 11-3, . . . , and 11-n.

When the reference point p in the first image 100-1 is an object point present on a planar surface parallel to an image plane of the corresponding camera and when the same object point appears at a position p+d in the second image 100-2, the same objet point may appear at a position p+2d in the third image 100-3, a position p+4d in the fourth image 100-4, and a position p+4d in the fifth image 100-5. However, since there is no case where an ideal condition is satisfied, a small match error is likely to appear in the third image, the fourth image, and the fifth image of which the baseline gradually increases. For example, when an object point coincides with the reference point p in the first image 100-1 and with the target point p+d in the second image 100-2, the object point may appear at a position in an range of p+2d±1 in the third image 100-3. In this case, in order to compensate for the match error, the image disparity determination apparatus may set the ambiguity regions (i.e., ambiguity regions) in the multiple images 100-1, 100-2, 100-3, . . . , and 100-n according to a positional relationship among the multiple cameras 11-1, 11-2, 11-3, . . . , and 11-n.

α refers to an element in an ambiguity region A. When the ambiguity region A is set to ±N, elements of the ambiguity region A are {−N, −N+1, . . . , 0, 1, . . . , N−1, N}, and α refers to one of the elements.

The disparity increases by an amount of i•d with the baseline. The ambiguity region is set such that a search range for the least SSD value increases in proportional to i.

In Step S503, the image disparity determination apparatus may determine a disparity by searching the set ambiguity region. That is, the image disparity determination apparatus may determine the disparities of the respective images 100-1, 100-2, 100-3, . . . , and 100-n by calculating Equation 1.

Specifically, when determining the disparity for the third image, the image disparity determination apparatus obtains the least SSD values for the reference point p and other three points p+2d−1, p+2d, p+2d+1 in an ambiguity region of ±1. On the other hand, when determining the disparity for the fourth image, the least SSD values are obtained for the reference point and other five points in an ambiguity region of ±2 of the fourth image.

In addition, the image disparity determination apparatus may apply higher penalty values Pₐ to points that are spaced longer toward the left side or the right side from the center of the ambiguity region.

The image disparity determination apparatus determines the disparity for each of the image by calculating Equation 2 and Equation 3. For this, the image disparity determination apparatus calculates a color coherence cost function C₂(p, d) between the reference image and each of the other images to obtain the average of C₂ⁱ. In the case of using SGM, a cumulative cost function Lᵣ(p, d) is calculated by multiplying C₂(p, d) by an SSD cost value normalization coefficient of 1/λ and adding the product to an existing C₁(p, d).

FIG. 6 is a flowchart illustrating an image disparity determination method according to another embodiment of the present disclosure.

Referring to FIG. 6, in Step 601, the image disparity determination apparatus determines a reference image and a target image among multiple images 100-1, 100-2, 100-3, . . . , and 100-n that are the basis for generation of a multibaseline stereo image (110 in FIG. 1) and determines a reference disparity between the reference image and the target image. The first image 100-1 may be determined as the reference image and the n-th image 100-n farthest from the reference image (i.e., first image 100-1) may be determined as the target image.

As described above, the reference disparity may be determined through stereo matching between the reference image and the target image. Specifically, the image disparity determination apparatus may determine the reference disparity on the basis of stereo matching. That is, the image disparity determination apparatus sets a reference point in the reference image and detects a target point corresponding to the reference point in the target image. In this case, the detection is performed using an SGM cumulative cost function or a matching cost function such as sum of squared difference (SSD), sum of absolute difference (SAD), mutual information (MI), and Census.

In Step S602, the image disparity determination apparatus determines ambiguity regions in the respective images 100-1, 100-2, 100-3, . . . , and 100-n according to the positional relationship among the cameras 11-1, 11-2, 11-3, . . . , and 11-n.

When the target point corresponding to the reference point p in the reference image 100-1 is set to a position p+d in the target image, the matching point in the n-th image 100-n is set to a position

$$p + \frac{n - 1}{n} ,$$

the matching point in the n−1th image 100-(n−1) is set to a position

$$p + \frac{n - 2}{n} ,$$

the matching point in the second image 400-2 is set to a position

$$p + \frac{1}{n} .$$

In this case, the matching point in the n-th image 100-n with respect to the target point is determined through interpolation of d-axis values of the positions

$$p + \frac{n - 2}{n} and p + \frac{1}{n}$$

respectively in the third image 100-3 and the second image 100-2.

Accordingly, in Step S603, the image disparity determination apparatus calculates SSD cost values (C₂ⁱ) for each base line which is a distance between the reference image 100-1 and a corresponding one of the other images 100-2, 100-3, and 100-(n−1)), and normalizes the SSD cost values on the basis of the SSD cost value for the maximum base line.

The final C₂(p, d) is determined with the average of the interpolated SSD cost values C₂ⁱ as in the case of the minimum baseline and the SGM can be applied by calculating the cumulative cost function (Lᵣ(p, d)) in the same manner.

That is, the image disparity determination apparatus calculates the SSD cost value through the d-axis interpolation.

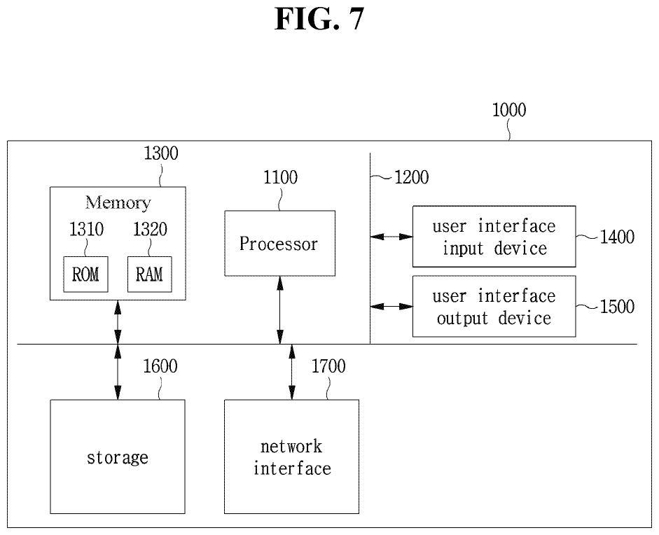

FIG. 7 is a block diagram illustrating the configuration of an exemplary computing system by which an image disparity determination method and apparatus according to an exemplary embodiment of the present disclosure are implemented.

Referring to FIG. 7, a computing system 100 may include at least one processor 1100 connected through a bus 1200, a memory 1300, a user interface input device 1400, a user interface output device 1500, a storage 1600, and a network interface 1700.

The processor 1100 may be a central processing unit or a semiconductor device that processes commands stored in the memory 1300 and/or the storage 1600. The memory 1300 and the storage 1600 may include various volatile or nonvolatile storing media. For example, the memory 1300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 1100, or a combination of the modules. The software module may reside in a storing medium (that is, the memory 1300 and/or the storage 1600) such as a RAM memory, a flash memory, a ROM memory, an EPROM memory, an EEPROM memory, a register, a hard disk, a detachable disk, and a CD-ROM. The exemplary storing media are coupled to the processor 1100 and the processor 1100 can read out information from the storing media and write information on the storing media. Alternatively, the storing media may be integrated with the processor 1100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. A method of determining a disparity of an image generated by using a multi-baseline stereo camera system, the method comprising:
determining a reference parity between a reference image and a target image among multiple images generated by using a multi-baseline stereo camera system;
determining an ambiguity region in each of the multiple images on the basis of the reference disparity and a positional relationship among the multiple images or among cameras in the multibaseline stereo camera system; and
determining a disparity for each of the multiple images by determining a matching point in each of the ambiguity regions of the respective images.

2. The method according to claim 1, wherein:
an image nearest the reference image is set as the target image; and
the determining of the ambiguity region in each of the multiple images includes determining target points that are set to correspond to an integer multiple of the reference disparity, on the basis of a positional relationship among the multiple images or among cameras in the multibaseline stereo camera system.

3. The method according to claim 1, wherein the determining of the ambiguity region in each of the multiple images includes setting a predetermined area centered at the target point as the ambiguity region.

4. The method according to claim 2, wherein the determining of the ambiguity region in each of the multiple images includes setting a size of the ambiguity region on the basis of the positional relationship between the multibaseline stereo camera system and each of the multiple images.

5. The method according to claim 4, wherein the ambiguity region in a third neighboring image is set to be larger than the ambiguity region in a second neighboring image, wherein the second neighboring image is arranged by the target image and the third neighboring image is arranged by the second neighboring image.

6. The method according to claim 5, wherein the process of setting the size of the ambiguity region is performed such that:
an area ranging from a point shifted by +n from the target point to a point shifted by −n from the target point is set as the size of the ambiguity region, within the second neighboring image; and
an area ranging from a point shifted by +2n from the target point to a point shifted by −2n from the target point is set as the size of the ambiguity region, within the third neighboring image, on the basis of the positional relationship between the multibaseline stereo camera system and each of the multiple images.

7. The method according to 1, wherein:
an image farthest from the reference image is set as the target image; and
the determining of the ambiguity region in each of the multiple images includes a process of checking a target point obtained by diving an integer multiple of the reference disparity by n−1, on the basis of a positional relationship among the multiple images or among cameras in the multibaseline stereo camera.

8. An apparatus for determining a parity of an image, the apparatus comprising:
a reference disparity determination unit configured to determine a reference disparity between a reference image and a target image among multiple images generated by using a multibaseline stereo camera system;
an matching region determination unit configured to determine an ambiguity region in each of the multiple images, on the basis of the reference disparity and on a positional relationship among the multiple images or among cameras in the multibaseline stereo camera system; and
a disparity determination unit configured to determine a disparity for each of the multiple images by determining a matching point in each of the ambiguity regions of the respective images of the multiple images.

9. The apparatus according to claim 8, wherein an image nearest the reference image, among the multiple images, is set as the target image.

10. The apparatus according to claim 9, wherein the matching region determination unit sets the ambiguity region centered at a target point according to an integer multiple of the reference disparity, on the basis of a positional relationship among the multiple images or among cameras in the multibaseline stereo camera system.

11. The apparatus according to claim 8, wherein an image farthest from the reference image is set as the target image.

12. The apparatus according to claim 11, wherein the matching region determination unit checks a target point obtained by diving an integer multiple of the reference disparity by n−1, on the basis of a positional relationship among the multiple images or among cameras in the multibaseline stereo camera system.
